(19) United States
(12) Patent Application Publication
(10) Pub. No.: US 2008/0016780 A1
(43) Pub. Date: Jan. 24, 2008

(54) Vault cover hinge and latch

(76) Inventors: Lawrence S. McDougle, Oceanside, CA (US); Scott Higley, San Marcos, CA (US)

Correspondence Address: STETINA BRUNDA GARRED & BRUCKER, 75 ENTERPRISE, SUITE 250, ALISO VIEJO, CA, 92656, US

(21) Appl. No.: 11/489,005

(22) Filed: Jul. 19, 2006

(51) Int. Cl. E05F 1/00

(52) U.S. Cl. 49/387

(57) ABSTRACT

A vault cover assembly including a vault door and a vault frame is disclosed. The vault door may be rotatably mounted to the vault frame, and have an open first position and a second closed position. The vault cover assembly may include a biasing member with a first arm and a second arm. There may also be a support member which cooperates with the biasing member. The vault cover assembly may also include a lever lock rotatably mounted to the vault door, which may include a latch configured to engage a latch stop mounted to the vault frame.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field

The present invention generally relates to vault cover assemblies. More particularly, the present invention relates to lift assist devices and locking mechanisms for use in cooperation with the vault cover assembly.

2. Related Art

Modern conveniences such as cable television, broadband internet, and telephone services, as well as the more basic utilities such as sewage, water, gas, and electricity are typically routed underground for safety, aesthetic, and other reasons. The lines and pipes associated with such utilities are typically organized into main lines serving a particular area, with branch lines extending from the main lines and providing service to individual customers. There may be several levels in the hierarchy of main and branch lines, and at each junction there may be an underground vault that houses access points for maintenance purposes and the like.

To prevent accidental or unauthorized access, the vaults are typically closed off with doors, covers, and so forth. A vault cover assembly generally includes a door and a frame embedded into a surrounding ground surface, such as concrete, asphalt, and so forth. Because the vaults are located underground and must be accessed from above ground, the door is hinged along a non-vertical hinge line and must be opened or closed against the force of gravity. Since vault doors are typically located in areas where foot traffic and/or vehicle traffic is expected, such doors must be extremely strong and accordingly quite heavy. Largely due to its weight, opening and closing vault doors can be dangerous. The door has a tendency to close very quickly upon release and to cause strain-related injuries while attempts are made to open it.

In response to these deficiencies, a number of assist mechanisms have been developed. One type of mechanism is the pneumatic assist, in which a piston reciprocating within a cylinder is mounted across the door and the frame. More specifically, the cylinder is mounted to either the door or the frame, and the piston is mounted to the other. Further, the pressure within the cylinder is biased to the expanded position, i.e., the open position of the door. Closing the door increases the pressure within the cylinder and is not released until opening. However, pneumatic assist devices are deficient, particularly in high moisture-content environments, because of corrosion and ultimate failure of the piston, the cylinder, and the various sealing gaskets, etc. contained therein. Thus, while highly efficient and powerful, pneumatic assist devices require constant maintenance and are expensive to install.

Another type of mechanism is the torsion bar assist, which typically includes a unitary spring steel torsion bar braced to opposing sides of the frame, with a connector rod integral with the torsion bar secured to the door. The torsion bar provides a counterbalance force and resists the gravitational pull upon the door, thereby preventing the same from closing, or at the very least, from closing too quickly. By applying further force to close the door, the torsion bar is twisted, and maintained in such a state until the door is subsequently opened. There are a number of deficiencies related to the torsion bar assist as well. Specifically, the torsion bar is maintained in a stressed state for a majority of its operational life, and so due to fatigue, the strength of the counterbalance decreases significantly over time. Additionally, fatigue-induced fractures increase the possibility of catastrophic failure, such as disintegration of the torsion bar with fragments thereof being scattered at high speed with high power, leading to property damage and injury.

As indicated above, the vault door is closed for the majority of its operational life. Conventionally, the vault door is secured shut with a slam latch, or a wedge-shaped bolt. As the door is closed, the slam latch retracts into its housing on the door while sliding over the strike plate, and is engaged to a hole defined by the strike plate and the frame. Since the bolt will not slide over the strike plate in the reverse direction, the door is secured. However, there are a number of notable deficiencies with the well-known slam latch mechanism. One problem is the vibration caused by the already loose fit between the slam latch, the strike plate, and the frame. Further, the loose fitting is worsened with further impact upon the door from motor vehicle travel, and to a lesser extent, foot travel. Additionally, impact from these sources generates a substantial amount of noise. Another problem is that a special tool is required to disengage the slam latch from the frame, or other additional release mechanisms must be incorporated into the door, possibly compromising security and durability.

Therefore, there is a need in the art for an improved vault cover assembly, including an improved lift assist and an improved locking mechanism, each of which overcomes the deficiencies described above.

### BRIEF SUMMARY OF THE INVENTION

According to an aspect of the present invention, there is provided a vault cover assembly. The vault cover assembly may include a vault frame, and a vault door rotatably mounted to the vault frame. The vault door may have an open first position and a closed second position. The vault cover assembly may also include a biasing member having a first arm and a second arm, as well as a support member that may couple the biasing member to the vault door and the vault frame. Additionally, the vault cover assembly may include a latch stop mounted to the vault frame, and a lever lock rotatably mounted to the vault door. The lever lock may include a latch for engaging the latch stop. The biasing member and the support member may be housed within an enclosure. The support member may extend from the enclosure and may be coupled to the vault door and the vault frame.

In accordance with another aspect of the present invention, the vault cover assembly may also include an auxiliary latch stop mounted to the vault frame. Further, there may be a connecting rod attached to the lever lock, and an auxiliary latch coupled to the connecting rod. The auxiliary latch may be engaged to the auxiliary latch stop. The vault cover assembly of the present invention may include a counter support element attached to the vault door, which is configured to engage the lever lock. The lever lock may include an arcuate indent to engage the support element.

In another embodiment of the present invention, there is a device for providing lift assist in a vault door rotatably coupled to a vault frame. The vault door may include a planar door panel and a door rail. The device may include a torsion coil spring that may have a first cable end section biased against the vault door, a second cable end section biased against the vault frame, and a coiled body section. There may also be included a locator bushing defining a receiving bore, which may be configured to be disposed within the coiled body section. The device may also include a pivot pin defined by a proximal end and a distal end. The pivot pin may be disposed within the receiving bore and supported by the vault door and the vault frame.

In yet another embodiment of the present invention, there is a locking mechanism for a vault door rotatably coupled to a vault frame. The vault door may include a planar door panel, a first door rail, and an opposed second door rail. The locking mechanism may include a lever lock defined by a first cam locking latch and an arm. The arm may define an indent, and the lever lock may be rotatably mounted to the first door rail. Additionally, there may be an offset tab mounted to the vault door, and the lever lock may be selectively engageable to the indent of the arm. A first locking latch stop may be mounted to the vault frame and be selectively engageable to the first cam locking latch.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a double door vault cover assembly with a closed vault door and an open vault door with a biasing member and a lever lock in accordance with an aspect of the present invention;

FIG. 2 is a perspective view of a reverse side of the vault door with a lift assist device installed thereon;

FIG. 3 is an exploded perspective view of the lift assist device;

FIG. 4 is a detailed perspective view of the vault door in a closed position in relation to the vault frame;

FIG. 5 is a side view of the vault door and the vault frame, with the lever lock in an engaged position with respect to the latch stop illustrated with solid lines, the lever lock in a disengaged position with respect to the latch stop shown with broken lines, and the lift assist device according to an aspect of the present invention;

FIG. 6 is a detailed perspective view of the lever lock engaged to the latch stop mounted to the vault frame; and

FIG. 7 is a side view of the vault door being rotatingly lifted from the vault frame.

### DETAILED DESCRIPTION

The detailed description set forth below in connection with the appended drawings is intended as a description of the presently preferred embodiment of the invention, and is not intended to represent the only form in which the present invention may be constructed or utilized. It is further understood that the use of relational terms such as first and second, top and bottom, and the like are used solely to distinguish one from another entity without necessarily requiring or implying any such actual relationship or order between such entities.

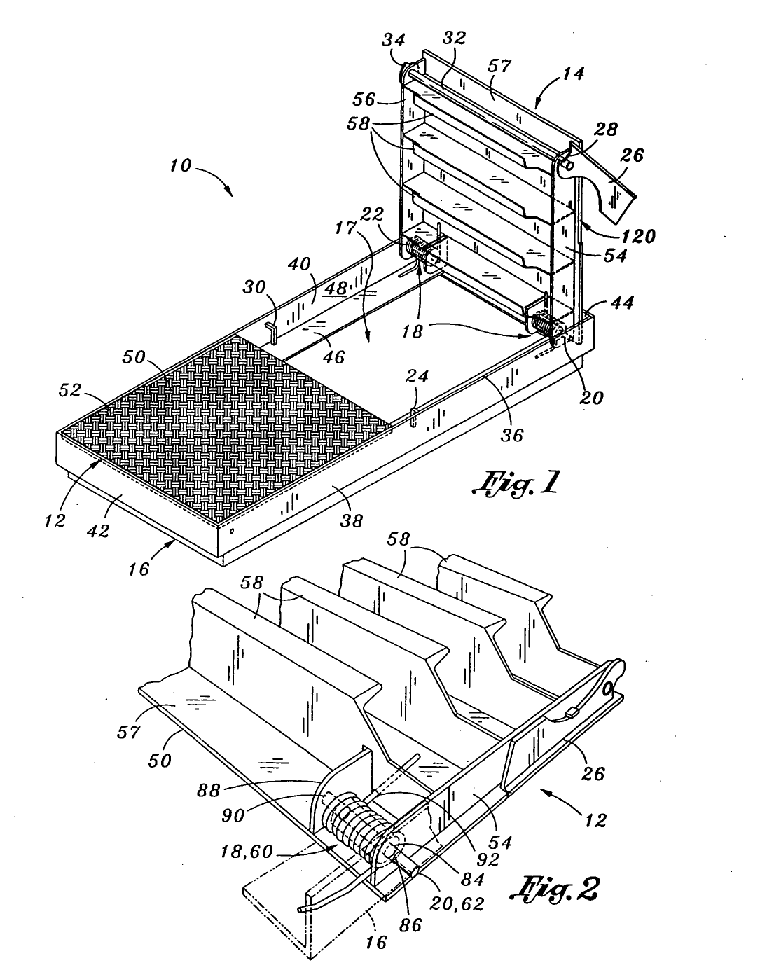

With reference now to FIG. 1, a vault cover assembly 10 having first and second vault doors 12, 14 rotatably mounted on a vault frame 16 is illustrated. The first vault door 12 is shown in a closed position, and the second vault door 14 is shown in an open position. It is understood that while FIG. 1 illustrates a double door configuration, it is by way of example only and not of limitation, and it is expressly contemplated that single doors may be substituted without departing from the scope of the present invention. According to an aspect of the present invention, there is provided a biasing member 18 for lift assist and buffering. The biasing member 18 is coupled to a support member 20, as well as to the first vault door 12 and the vault frame 16. The biasing member 18 may be housed within an enclosure 22, with the support member 20 extending therefrom. According to another aspect of the present invention, there is provided a latch stop 24 mounted to the vault frame 16, and a lever lock 26 including a latch 28 configured to be engaged thereto. In one embodiment, there is an auxiliary latch stop 30 mounted to the vault frame 16, a connecting rod 32 coupled to the lever lock 26, and an auxiliary latch 34 coupled to the connecting rod 32.

Further particulars relating to each of these aspects of the present invention will be described in greater detail below. It will be understood that while the aforementioned components of the vault cover assembly 10 may be more specifically and differently referenced below, such references are intended to be for purposes of example only and are not intended to be limiting with respect to the broader, more generalized references.

As will be recognized by one of ordinary skill in the art, the frame 16 and an aperture 17 defined thereby provide an opening into an underground vault. The frame 16 is typically flush mounted into a pavement surface, such that a top rim portion 36 of the frame 16, along with the top surface 30 of the vault doors 12, 14 are exposed. As an alternative to removing pavement to fit the vault cover assembly 10, the pavement may be poured around the same after installation on the underground vault. In further detail, the frame 16 is comprised of a pair of opposed left and right L-shaped frame rails 38, 40, and a pair of opposed upper and lower frame stiles 42, 44 oriented perpendicularly thereto. The left and right frame rails 38, 40 each define an inner horizontal surface 46, and an inner vertical surface 48. Preferably, the vault frame 16, and thus all its constituent parts, is constructed of a lightweight, non-corrosive material such as an aluminum alloy. However, it will be appreciated by one of ordinary skill in the art that the present invention is not limited to any particular material, and other materials such as steel, iron, etc. may be readily substituted, depending on the intended use and environmental conditions.

With respect to the first and second vault doors 12, 14, for the sake of convenience the features visible on the top side will be described with reference to the first vault door 12, and the features visible on the under side will be described with reference to the second vault door 14. It is understood, however, that the first vault door 12 includes all of the features as described in relation to the second vault door 14, and vice versa. As shown in FIG. 1, the first vault door 12 includes a planar door panel 50, which includes tread patterns 52 formed thereon. Typically, the tread patterns 52 are diamond-shaped, and may either be extruded or engraved. It will be readily recognized by one of ordinary skill in the art that the tread patterns 52 are provided for increasing traction over the smooth metallic surface of the planar door panel 50 for improved safety. This is particularly important in wet environments where loss of traction in relation to vehicle or pedestrian traffic may have disastrous consequences. The use and configuration of the tread patterns 52 are well known in the art, and any other pattern may be substituted.

As will be apparent from the view of the second vault door 14, a reverse under side 57 of the planar door panel 50 is smooth, that is, there are no tread patterns. The reverse under side 57 further includes left and right door rails 54, 56, which have a height sufficient to enable the planar door panel 50 to rest flush with the top rim portion 36 of the vault frame 16. The second vault door 14 includes support beams 58 extending from the left and right door rails 54, 56. The support beams 58 are of a sufficient length to space apart the left and right door rails 54, 56 to pivotally couple the second vault door 14. More specifically, the dimension across the first and second door rails 54, 56 is less than the dimension across the first and second frame rails 38, 40. In this regard, the second vault door 14 rotates within the confines of the vault frame 16, since as indicated above, the vault frame 16 is typically surrounded by pavement material. Further details with respect to the hinge mechanism that enables the vault door 14 to pivot about the vault frame 16 will be described below. It will be appreciated by one of ordinary skill in the art that the support beams 58 brace the door panel 50 and distribute twisting and bending stresses applied thereto during normal operating cycles, such as traffic passing over or opening and closing the vault doors 12, 14. In addition to this functionality, the support beams 58 provide additional support to the left and right door rails 54, 56. Again, as indicated in relation to the description of the vault frame 16, the first and second vault doors 12, 14 are preferably constructed of aluminum or other lightweight metal, but stainless steel or iron may be used instead. One of ordinary skill in the art will appreciate the various possible configurations of the first and second doors 12, 14, and will be able to readily ascertain the suitability of one design over another depending on its intended application. Thus, as understood, the particulars described hereinabove with respect to the first and second vault doors 12, 14 are presented by way of example only, and not of limitation.

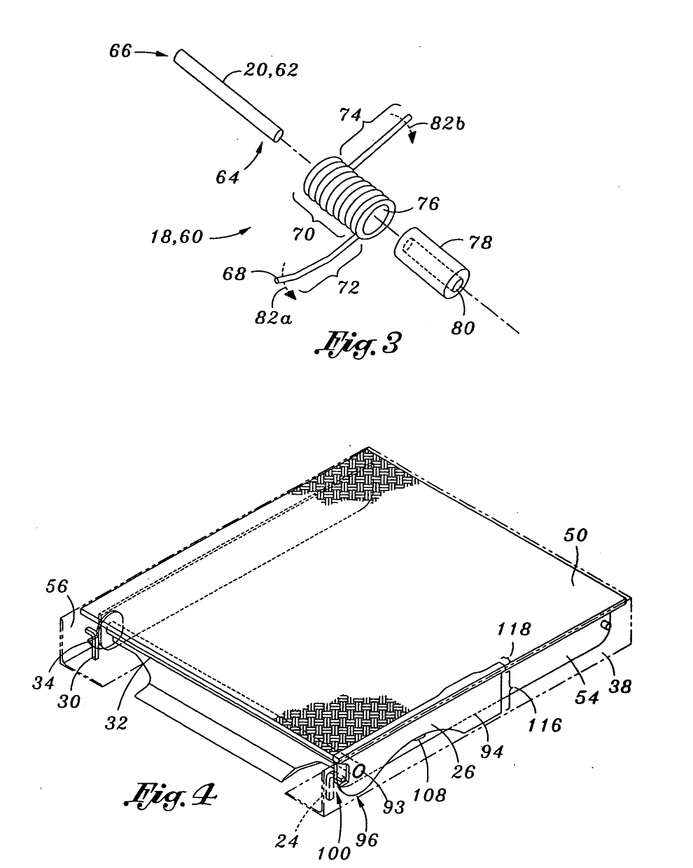

Having considered the basic construction of the vault frame 16 as well as the first and second vault doors 12, 14, the particular mechanism by which the first and second vault doors 12, 14 are pivotally coupled to the vault frame 16 in accordance with a preferred embodiment of the present invention will be discussed. With reference now to FIG. 2, there is shown an exemplary first vault door 12 with the planar door panel 50 defining the reverse under side 57. Also illustrated are the aforementioned support beams 58, and the left door rail 54. The left door rail 54 is slightly offset inwards from the edge of the planar door panel, for reasons discussed more fully below.

According to a preferred embodiment, with reference to FIGS. 2 and 3, the biasing member 18 is more particularly referred to as a torsion coil spring 60, and the support member 20 is more particularly referred to as the pivot pin 62. The torsion coil spring 60 is preferably a stainless steel cable 68 wound into a coil to define a coiled body section 70. The coiled body section 70 further defines a hollow portion 76 substantially cylindrical in shape. The parts of the cable which are not a part of the coiled body section 70 are referred to as first and second biasing arms 72, 74. Starting from the first biasing arm 72, the cable 68 is wound in a counter-clockwise direction towards the second biasing arm 74. Accordingly, the coil spring 60 biases the first and second biasing arms 72, 74, in the directions indicated in axes 82a, 82b, meaning that despite force being applied in the direction opposite to the axes 82a, 82b, the first and second biasing arms 72, 74 have a natural tendency to counteract such force and return to its original position. This resistive force is significantly greater in compression as just described, rather than in expansion, where additional force beyond a predetermined threshold is applied in the direction of the axes 82a, 82b tends to unravel the coil spring 60. Along these lines, it is understood that as the first and second biasing arms 72, 74 have force applied in the direction opposite to axes 82a, 82b, the coil body section 70 is compressed. This compressive force is distributed across the entirety of the coil body section 70, and slightly decreases the diameter of the same.

Disposed within the hollow portion 76 is a locator bushing 78, which according to a presently preferred embodiment, is constructed of durable material capable of holding its shape under load because it is necessary for it to resist the aforementioned compressive force. One exemplary material contemplated is DELRIN, a polymer/acetal resin available from E.I. du Pont de Nemours and Company of Wilmington, Del. It will be appreciated that such material may also provide self-lubrication features, which is beneficial in reducing maintenance costs and the necessity of incorporating costly lubrication means to the torsion coil spring 60. The locator bushing 78 defines a pin receiving bore 80, which receives and generally conforms to the shape of the pivot pin 62. Generally, the pin receiving bore 80 is coaxial with the locator bushing 78 and the coiled body section 70, but in one embodiment the pin receiving bore 80 is offset.

With regard to the pivot pin 62, it is understood to be a unitary cylindrical structure having a proximal end 64 and a distal end 66, which, as indicated above, is inserted into the pin receiving bore 80. As discussed in relation to the support member 20 of FIG. 1, the corresponding pivot pin 62 serves as a mechanism for coupling the first vault door 12 to the vault frame 16. Considering all of the above, it will become apparent to one of ordinary skill in the art that the locator bushing 78 permits the pivot pin 62 to freely rotate despite increasing compressive forces upon the interior of the coil body section 70. In other words, movement of the pivot pin 62 that would otherwise encounter resistance from the coil body section 70 constricting the free movement of the pivot pin 62 if directly interfaced thereto is buffered with the locator bushing 78.

In further detail with regard to coupling the vault door 12 to the vault frame 16, in a preferred embodiment the pivot pin 62 is inserted through a door pin hole 84 and a frame pin hole 86. The region of the pivot pin 62 in close proximity to the proximal end 64 thereof is supported by the door pin hole 84 and the frame pin hole 86. The region of the pivot pin 62 in close proximity to the distal end thereof is supported by a stator wall 88 and a pin hole 90 defined thereby. The stator wall 88 is understood to be disposed on the planar door panel 50 parallel to the left door rail 54, and perpendicular to the support beam 58. The support beam 58 defines an arm aperture 92, and the second biasing arm 74 is inserted therethrough.

As indicated above, the first biasing arm 72 is biased such that there is a spring force being applied in the direction of axis 82a, that is, against the vault frame 16. Furthermore, the second biasing arm 74 is biased such that there is a spring force being applied in the direction of axis 82b, against the vault door 12. Accordingly, when the vault door 12 is closed, the coil spring 60 is compressed. Upon opening the vault door 12, the coil spring 60 provides lift assist via the aforementioned spring forces in the direction of the axes 82a, 82b. When closing the vault door 12, the coil spring 60 resists the gravitational forces which are opposite in direction of the axes 82a, 82b, and gently lowers the vault door 12 onto the vault frame 16. Although the embodiment of FIG. 2 illustrates the coil spring 60, the pivot pin 62, and the locator bushing 78 as discrete units individually arranged and attached to the vault door 12, it is expressly contemplated, that such components may be housed within a single enclosure. Such a modular enclosure may be retrofitted to existing vault doors.

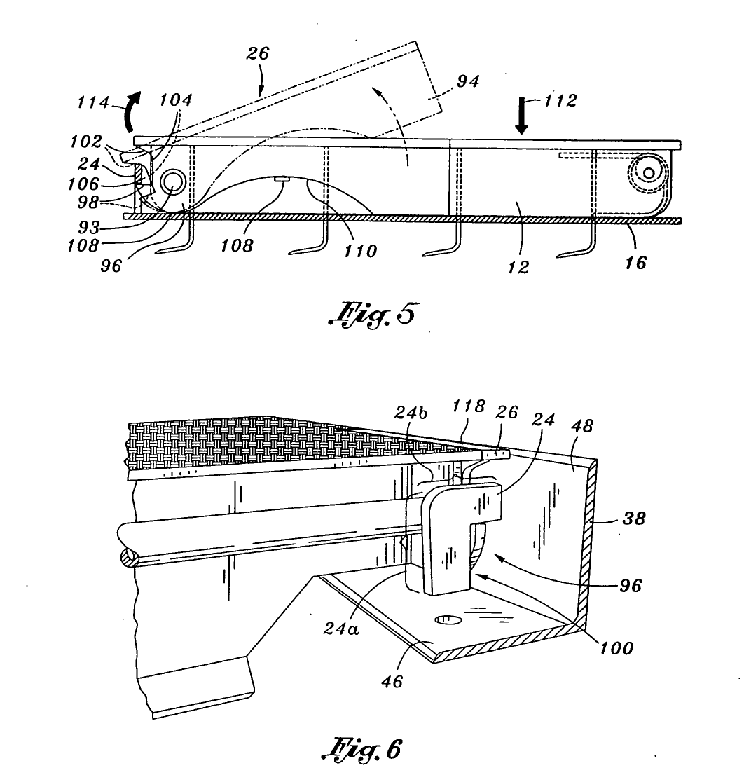

With reference now to FIGS. 4-7, further details of the mechanism for retaining the vault door 12 in a closed position will be explained. As indicated above and as shown in FIG. 4, the lever lock 26 is rotatably mounted to the left door rail 54 about a center point 93. Details of the lever lock 26 are further illustrated in FIG. 5, which depicts in solid lines the lever lock 26 in a locked position engaged to the latch stop 24, and in ghosted lines, the lever lock 26 in an unlocked position disengaged with the latch stop 24. FIG. 7 illustrates the vault door 12 being opened after disengaging the lever lock 26 from the latch stop 24.

The lever lock 26 defines a lever arm 94 and a first cam locking latch 96. The first cam locking latch 96 includes a slanted portion 102, a vertical portion 104, and a locking surface 98, which in combination defines a notch 106. The latch stop 24 is attached to the frame rail 38, and is in an L-shaped configuration having a vertical section 24a and a horizontal section 24b with attachment points on the inner horizontal surface 46 and the inner vertical surface 48. In conjunction with the frame rail 38, the latch stop 24 defines a void 100. The notch 106 is configured such that prior to locking, the slanted portion 102 abuts the vertical section 24a, preventing the lever lock 26 from rotating beyond that allowed by the latch stop 24. It is understood that the notch 106 is also sized and configured for the locking surface 98 to engage only the latch stop 24 as it is rotated, and prevent any other surface, such as the slanted portion 102 or the vertical portion 104, from engaging the latch stop 24. Along these lines, it is contemplated that the size of the notch 106 relative to the height of the void 100, and thus the size of the latch stop 24, is such that there is no interference from the latch stop 24 while opening the vault door 12. In other words, when the lever lock 26 is rotated to the point in which the slanted portion 102 abuts the latch stop 24, rotating the vault door 12 to open the same will not result in the locking surface 98 to catch the latch stop 24. Additionally, the first cam locking latch 96 is defined by an arcuate surface 108 for the smooth rotation of the lever lock 26 about the horizontal section 24b of the frame 24.

With reference to FIGS. 1 and 4, according to a preferred embodiment of the present invention, the aforementioned locking mechanism disposed on the left door rail 54 and left frame rail 38 may be duplicated on the right door rail 56 and the right frame rail 40. As described above, the lever lock 26 is rotatably mounted about the center point 93, and such rotation may be transferred via the connection rod 32. The connection rod 32 is coaxial with the center point 93, and spans between the left and right door rails 54, 56. Furthermore, the connection rod 32 is coupled to the auxiliary latch 34. The functionality of the first cam locking latch 96 is essentially duplicated, or emulated, by the auxiliary latch 34, and includes its constituent parts. Further, the functionality of the first latch stop 24 is duplicated by the auxiliary latch stop 30. It is understood that the locking mechanism operates in the same fashion as described above in relation to the first cam locking latch 96, and that the auxiliary latch 34 further strengthens the locking relation between the vault door 12 and the vault frame 16. The locking relation is controlled from a single point, that is, the lever lock 26.

In order to reduce vibration when downward force is applied to the planar door panel 50, there is provided an offset tab 108 mounted to the vault door 12. Specifically, the lever lock 26 defines an indent 110, which in a preferred embodiment is parabolic as shown in FIG. 5. The indent 110 is configured such that when engaged to the offset tab 108, the lever lock 26 lies flush with the planar door panel 50. With reference to FIG. 5, it will be appreciated that when download force is applied to the planar door panel 50, as per direction 112, the first cam locking latch 96 rotates clockwise per direction 114. In this regard, the lever lock 26 likewise rotates in a clockwise direction, resulting in the locking surface 98 alternating between a loosely engaged state and tightly engaged state with respect to the latch stop 24. Essentially, the first cam locking latch 96 and the latch stop 24 provides a constant compressive force upon the vault door 12, pulling the same into the vault frame 16. The offset tab 108 counters the tendency of the lever latch 26 to rotate in the aforementioned clockwise direction, and thus reduces vibration.

In order to prevent unauthorized access, the vault cover assembly 10 may be provided with security devices such as combination or key lock devices inserted between the vault door 12 and the vault frame 16. Such devices are well known, and those having ordinary skill in the art will be able to readily ascertain the use and configuration of such devices. It is to be understood that any such alternatives are deemed to be within the scope of the present invention.

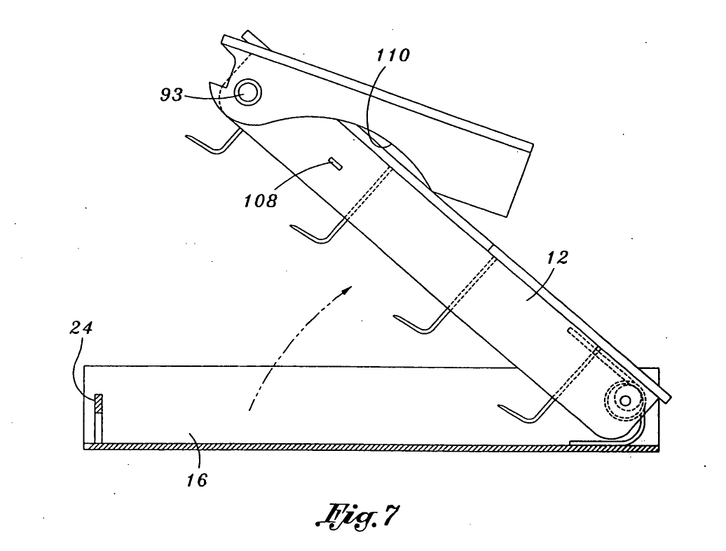

As the vault cover assembly 10 of the present invention is intended for covering vaults located under roads and other pavements with vehicular traffic, it is necessary to eliminate any protrusions from the planar door panel 50. Accordingly, with reference to FIGS. 4 and 6, the lever lock 26 is illustrated as being flush with the planar door panel 50. More specifically, the lever lock 26 is defined by a vertical plate section 116, and a perpendicularly oriented flange section 118 that is flush with the planar door panel 50. With reference to FIG. 1, to accommodate the flange section 118, the planar door panel 50 includes a slot 120. The slot 120 is equivalent in width to that of the flange section 118. It is understood that the planar door panel 50 and the flange section 118 are coplanar with the top rim portion 36 of the vault frame 16, but alternatively, the planar door panel 50 and the flange section 118 may cover the top rim portion 36.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A vault cover assembly comprising:
a vault frame;
a vault door rotatably mounted to the vault frame, the vault door having an open first position relative to the vault frame and a closed second position relative to the vault frame;
a biasing member having a first arm and a second arm;
a support member coupling the biasing member to the vault door and the vault frame;
a latch stop mounted to the vault frame; and
a lever lock rotatably mounted to the vault door, the lever lock including a latch for engaging the latch stop.

2. The vault cover assembly of claim 1, wherein the biasing member and the support member are housed within an enclosure, the support member extending from the enclosure and coupled to the vault door and the vault frame.

3. The vault cover assembly of claim 1, further comprising:
an auxiliary latch stop mounted to the vault frame;
a connecting rod attached to the lever lock; and
an auxiliary latch coupled to the connecting rod for engaging the auxiliary latch stop.

4. The vault cover assembly of claim 1, further comprising a counter support element attached to the vault door and engaging the lever lock.

5. The vault cover assembly of claim 4, wherein lever lock includes an arcuate indent to engage the support element.

6. A device for providing lift assist in a vault door rotatably coupled to a vault frame, the vault door including a planar door panel and a door rail, the vault assist device comprising:
a torsion coil spring having a first cable end section biased against the vault door, a second cable end section biased against the vault frame, and a coiled body section;
a locator bushing defining a receiving bore, the locator bushing being disposed within the coiled body section; and
a pivot pin defined by a proximal end and a distal end, the pivot pin being disposed within the receiving bore and supported by the vault door and the vault frame.

7. The device of claim 6, wherein the pivot pin is inserted through a door pivot aperture defined by the door rail and a frame pivot aperture defined by the vault frame.

8. The device of claim 6, further comprising a support member fixed to the vault door, the section of the pivot pin in close proximity to the proximal end being supported by the vault door and the vault frame, and the section of the pivot pin in close proximity to the distal end being supported by a support member.

9. The device of claim 8, wherein the support member is a plate defining a support plate pivot aperture, the pivot pin being inserted through the support plate pivot aperture.

10. The device of claim 6, further comprising a modular enclosure housing the torsion coil spring, the locator bushing, and the pivot pin, the modular enclosure being attached to the vault door.

11. The device of claim 10, wherein first cable end section and the second cable end section projects from the modular enclosure.

12. The device of claim 6, wherein the vault door includes a support rail extending perpendicularly to the door rail, the support rail defining an aperture for receiving the first cable end section of the torsion coil spring.

13. The device of claim 6, wherein the locator bushing is comprised of a self-lubricating material.

14. A locking mechanism for a vault door rotatably coupled to a vault frame, the vault door including a planar door panel, a first door rail and an opposed second door rail, the locking device comprising:
a lever lock defined by a first cam locking latch and an arm defining an indent, the lever lock being rotatably mounted to the first door rail;
an offset tab mounted to the vault door, the lever lock being selectively engageable to the indent of the arm; and
a first locking latch stop mounted to the vault frame and being selectively engageable to the first cam locking latch.

15. The locking mechanism of claim 14, wherein the indent is parabolic.

16. The locking mechanism of claim 14, wherein the arm defines a first lock insertion hole coaxial with a second lock insertion hole defined by the vault door.

17. The locking mechanism of claim 14, wherein the lever lock is further defined by a flange perpendicular to the co-planar arm and the first cam locking latch.

18. The locking mechanism of claim 17, wherein the flange is coplanar with the planar door panel.

19. The locking mechanism of claim 18, wherein the flange and the planar door panel is flush against the vault frame.

20. The locking mechanism of claim 14, further comprising:
a connecting rod spanning the first door rail and the second door rail, the first cam locking latch being coaxially mounted to the connecting rod;
a second cam locking latch disposed adjacent to the second door rail and mounted to the connecting rod, the second cam locking latch being coaxial with the connecting rod; and
a second locking latch stop mounted to the vault frame and being selectively engageable to the second cam locking latch.
